(19) United States
(12) Patent Application Publication
(10) Pub. No.: US 2013/0179093 A1
(43) Pub. Date: Jul. 11, 2013

(54) METHOD OF CHARACTERIZING THE VISCOELASTIC PROPERTIES OF A SAMPLE, CORRESPONDING SYSTEM AND ANALYZER

(71) Applicant: Patrick Hanusse, Pessac (FR)

(72) Inventor: Patrick Hanusse, Pessac (FR)

(73) Assignee: CENTRE NATIONAL DE LA RECHERCHE SCIENTIFIQUE (C.N.R.S), Paris (FR)

(21) Appl. No.: 13/823,395

(22) PCT Filed: Sep. 16, 2011
(86) PCT No.: PCT/FR2011/052134

§ 371 Date: Mar. 14, 2013

(30) Foreign Application Priority Data
Sep. 17, 2010 (FR) 10 57452

(51) Int. Cl. G01N 29/44

(52) U.S. Cl. CPC G01N 29/44
USPC 702/33

(57) ABSTRACT

A method of characterizing viscoelastic properties of a sample of a substance, includes the application (52) to the sample of an oscillatory mechanical excitation, the measurement (54) of a response of the sample to the mechanical excitation and the determination (56, 58) of characteristic parameters of the viscoelastic properties of the sample, is characterized in that the determination (56, 58) of characteristic parameters includes the steps of expressing the response in the form of a nonlinear periodic response signal, of general form x(t)=x₀+x₁ cos(φ(t)−ρ₀), where φ(t) is the phase of the signal, and of determining viscoelasticity parameters, characterizing the nonlinearity of the response signal.

The present invention relates to a method for characterizing the viscoelastic properties of a sample of a substance, comprising the application to said sample of an oscillatory mechanical excitation, the measuring of a response of said sample to said mechanical excitation, and the determination of characteristic parameters of said viscoelastic properties of said sample.

It is often necessary, when studying the physicochemical properties of substances, to characterize the viscoelastic properties of the substances, i.e., their rheological behavior under a given bias. The substances are for example materials such as polymers or composite materials, slurries or suspensions, or biological tissues.

The characterization of these viscoelastic properties is generally done using a viscoanalyzer, by subjecting a sample of the substance to be analyzed to a sinusoidal excitation, and characterizing the linear response of the sample to that excitation. It therefore involves linear measurements.

The sample can thus be subjected to a sinusoidal deformation ε defined entirely by its amplitude ε₁ and its frequency f₁, the viscoelastic properties of the substance then being characterized by analyzing the amplitude σ₁ or the resulting stress σ transmitted by the material and its phase shift δ relative to the deformation ε. Thus, when the sample is subjected to a deformation of form ε=ε₁·sin(2πf₁t), the analyzed response signal is the opposite, which is expressed in the linear form σ=σ₁·sin(2πf₁t−δ). The amplitude σ₁ of the stress and its phase shift δ then make it possible to determine different characteristic parameters of the viscoelasticity of the sample, and in particular its loss factor tan and its modulus of elasticity, at the frequency f₁ and for a given temperature T₀. Furthermore, the outline of the isofrequency curve tan δ=f(T₀) makes it possible to determine the vitreous transition temperature T_{g} of the sample at the frequency f₁.

The viscoelastic properties of the substance can also be determined by conversely subjecting a sample of that substance to a sinusoidal stress σ=σ₁·sin(2πf₁t), and measuring the deformation ε of the sample in response to that stress, in the form of a linear signal ε=ε₁·sin(2πf₁t−δ).

The viscoelastic properties thus determined generally depend on the frequency f₁ of the excitation. In particular, the amplitude of the response by the sample to an excitation of a given amplitude depends on the frequency of that excitation, nonlinearly, and reaches a maximum at the resonance frequency of the sample. This resonance frequency in turn depends on the excitation amplitude.

Furthermore, the relationship between the amplitude of the deformation and the amplitude of the stress at a given frequency, which is linear for small deformation values, becomes nonlinear when that deformation increases.

The nonlinearity of the responses measured as a function of the experimental conditions (frequency, amplitude of the sinusoidal signal) is most often studied by representing the amplitude or the phase shift of those responses as a function of those experimental conditions.

However, the characterization methods according to the state of the art are all based on measuring the linear response of the analyzed sample to a linear excitation.

However, when a sample is subject to a linear excitation, deformation or stress, its response, stress or deformation is not strictly linear in turn, in particular when the excitation has a high amplitude. This response in fact comprises nonlinear components, which are not taken into account by the methods according to the state of the art, and which are, however, in turn characteristic of the viscoelastic properties of the analyzed sample.

The aim of the invention is therefore to allow a more accurate and more relevant characterization of the viscoelastic properties of samples of substances.

To that end, the invention relates to a characterization method of the aforementioned type, characterized in that the determination of said characteristic parameters comprises the following steps:

expressing said response in the form of a nonlinear periodic response signal, of general form x(t)=x₀+x₁ cos(φ(t)−ρ₀), where φ(t) is the phase of said signal and p₀ a phase origin, and

determining viscoelasticity parameters, characterizing the nonlinearity of said response signal.

The method according to the invention also includes the following features, considered separately or in combination:

the step for determining viscoelasticity parameters comprises determining expression of the phase φ(t) of said response signal as a function of viscoelasticity parameters measuring the anharmonicity of the response signal and its morphology, from functions p cosₙ and p sinₙ defined by:

$$p {cos}_{n} ( t , r ) = {\sum }_{k = 1}^{∞} cos ( kt ) \frac{{r}^{k}}{{k}^{n}}$$

$$and$$

$$p {sin}_{n} ( t , r ) = {\sum }_{k = 1}^{∞} sin ( kt ) \frac{{r}^{k}}{{k}^{n}} ;$$

the determination of an expression of the phase φ(t) of said response signal comprises the determination of an expression of a phase equation

$$F ( Φ ) = \frac{d Φ}{d t}$$

characterizing a variation speed of said phase;

said phase equation is expressed in the form:

$$\frac{d Φ}{d t} = \frac{1 + {r}^{2} + 2 r cos ( Φ )}{1 - {r}^{2}} ,$$

wherein r, varying in [0,1[, is a parameter measuring the nonlinearity of said response signal;

the response signal is expressed using at least two viscoelasticity parameters r and p₀ respectively characterizing the nonlinearity and the morphology of the response signal, in the form:

x(t)=x₀+a₁h cos(2πf₁t,r)+b₁h sin(2πf₁t,r)

where f₁ is the frequency of the signal, a₁=x₁ cos(ρ₀) and b₁=x₁ sin(ρ₀), the functions h sin and h cos being defined by:

$$h cos \text{:} ( t , r ) \to \frac{( 1 + {r}^{2} ) cos ( t ) + 2 r}{1 + {r}^{2} - 2 r cos ( t )}$$

$$and$$

$$h sin \text{:} ( t , r ) \to \frac{( 1 - {r}^{2} ) sin ( t )}{1 + {r}^{2} - 2 r cos ( t )} ;$$

said phase equation is expressed in the form:

$$F ( Φ ) = \frac{P ( Φ )}{Q ( Φ )} ,$$

wherein P(φ) and Q(φ) are trigonometric polynomials;

the expression of the phase φ(t) is determined as a function of viscoelasticity parameters in the form:

$$Φ ( t ) = 2 π {f}_{1} t + {\sum }_{k = 1}^{n} {a}_{k} p {sin}_{1} ( 2 π {f}_{1} ( t - {t}_{k} ) , {r}_{k} ) - {b}_{k} p {cos}_{1} ( 2 π {f}_{1} ( t - {t}_{k} ) , {r}_{k } )$$

wherein f₁ is the frequency of the signal and the functions p sin₁ and p cos₁ are defined by:

$$p {cos}_{1} ( t , r ) = {\sum }_{k = 1}^{∞} cos ( kt ) \frac{{r}^{k}}{k}$$

$$and$$

$$p {sin}_{1} ( t , r ) = {\sum }_{k = 1}^{∞} sin ( kt ) \frac{{r}^{k}}{k} .$$

According to another aspect, the invention also relates to a system for characterizing viscoelastic properties of a sample of a substance, comprising means for the application to said sample of an oscillatory mechanical excitation, means for the measurement of a response of said sample to said mechanical excitation, and means for the determination of characteristic parameters of said viscoelastic properties of said sample, characterized in that said means for the determination of said characteristic parameters comprise:

means for expressing said response in the form of a nonlinear periodic response signal, of general form x(t)=x₀+x₁ cos(φ(t)−p₀), where φ(t) is the phase of said response signal and p₀, is a phase origin, and

means for determining viscoelasticity parameters characterizing the nonlinearity of said response signal.

According to another aspect, the invention also relates to a dynamic mechanical analyzer comprising a characterization system according to the invention.

The invention will be better understood in light of one example embodiment of the invention that will now be described in reference to the appended figures, in which:

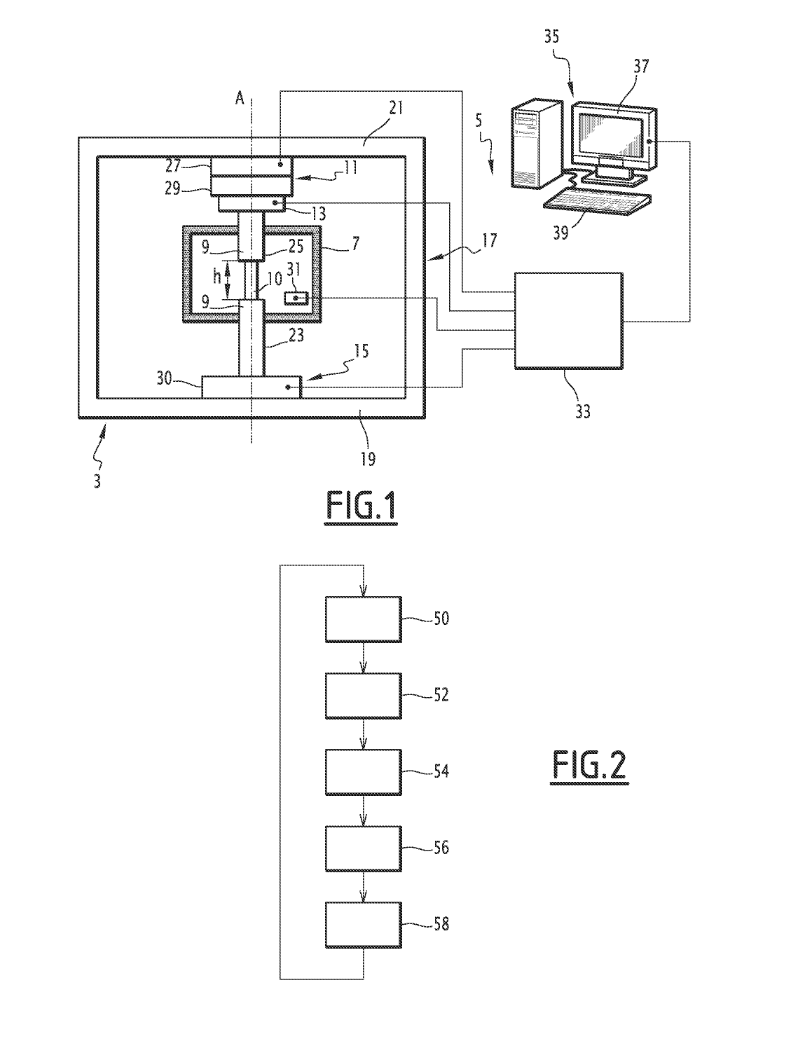

FIG. 1 is a diagram showing a characterization system according to one embodiment of the invention; and

FIG. 2 is an overview diagram illustrating the characterization method according to one embodiment of the invention.

FIG. 1 shows a system for characterizing viscoelastic properties of a sample of a material and a nonlinear system according to one embodiment of the invention.

The system comprises a viscoanalyzer 3, also called dynamic mechanical analyzer (DMA), shown in cross-section, and a control and analysis unit 5, connected to the viscoanalyzer 3.

In a known manner, the viscoanalyzer 3 in particular comprises a thermostatically-controlled enclosure 7, means 9 for fixing a sample 10 to be analyzed, means 11 for generating a sinusoidal excitation and applying that excitation to the sample 10, means 13 for determining the deformation of the sample 10, and means 15 for determining the stress transmitted by the sample 10.

The viscoanalyzer 3 also comprises a rigid mechanical frame 17, including a lower crosspiece 19 and an upper crosspiece 21.

The means 11 for generating and applying a sinusoidal excitation are fixed to the lower surface of the upper crosspiece 21. The means 13 for determining the deformation of the sample 10 are in turn fixed on the one hand to a lower surface of the means 11 for generating and applying a sinusoidal excitation, and on the other hand to the fixing means 9.

The fixing means 9 are also fixed to the means 15 for determining the stress applied on the sample 10, those means 15 in turn being fixed to the upper surface of the lower crosspiece 19.

The fixing means 9 for example comprise two support elements 23, 25 forming a vise designed to grip the sample 10. A first 23 of the support elements is fixed to the lower crosspiece 19 of the frame 17, the second support element 25 being fixed to the means 13 for determining the deformation of the sample. The elements 23, 25 are thus adapted to the application of a deformation of the traction-compression type to the sample 10.

The means 11 for generating and applying a sinusoidal excitation are capable of generating and applying a sinusoidal deformation to the sample 10. These means 11 in particular comprise a sinusoidal signal generator 27 with adjustable frequency and amplitude, capable of generating a sinusoidal electric signal with a selected frequency and amplitude. The means 11 also comprise an electrodynamic exciter 29, fixed to the support element 25 by the means 13 for determining and deforming the sample, and capable of generating, from said sinusoidal electric signal, a sinusoidal oscillatory displacement D of the element 25 relative to the frame along the vertical axis A, therefore a sinusoidal deformation ε of the sample 10, when it is held in a vise by the fixing means 9.

The means 13 for determining the deformation of the sample for example comprise a dynamic movement sensor coupled to an accelerometer.

The dynamic movement sensor is for example a capacitive sensor, capable of measuring the displacement D generated by the electrodynamic exciter 29, with a resolution of approximately a nanometer, generating an electric signal Ds(t) that is characteristic of that movement, and transmitting that signal Ds(t) to the control unit 5. The dynamic movement sensor therefore does not directly measure the deformation of the sample, but that deformation can be deduced from the displacement D by the relationship:

$$ɛ = \frac{D}{h} ,$$

wherein h designates a characteristic length of the sample 10, in a direction parallel to the axis A.

The accelerometer is for example a piezoelectric accelerometer or a closed-loop accelerometer, depending on the studied frequency range, and capable of measuring the acceleration generated by the electrodynamic exciter 29. The accelerometer is also capable of generating an electric signal As(t) that is characteristic of the acceleration, and transmitting that signal As(t) to the control unit 5.

The means 15 for determining the stress transmitted by the sample 10, positioned between the support element 23 and the lower crosspiece 19 of the frame 17, for example comprise a dynamic, capacitive and/or piezoelectric force sensor 30, depending on the studied frequency range. These means 15 are capable of determining the force transmitted by the sample 10 when it is subjected to a deformation generated by the electrodynamic exciter 29, generating an electric signal Fs(t) characteristic of that force, and transmitting that signal Fs(t) to the control unit 5. The means 15 thus do not directly determine the stress transmitted by the sample 10, but it can be deduced from the force F_{d} by the relationship:

F_{d}=σ*S (1)

wherein S designates the cross-section of the sample in the direction perpendicular to the axis A.

The thermostatically-controlled enclosure 7, fixed to the frame 17, heat-sealably contains the sample 10. It is capable of maintaining a selected constant temperature around the sample. It in particular comprises means 31 for measuring the temperature T₀ inside the enclosure, for example a thermocouple.

The control and analysis unit 5 is connected to the viscoanalyzer 3, and in particular to the means 31 for measuring the temperature, the means 11 for generating and applying a sinusoidal excitation, the means 13 for determining the deformation of the sample, and the means 15 for determining the stress transmitted by the sample 10.

The control and analysis unit 5 in particular comprises a processing unit 33, and interface means 35, for example a display device 37 and an input peripheral 39, connected to the processing unit 33.

The processing unit 33 is capable of controlling the thermostatically-controlled enclosure 7 so that the temperature around the sample is equal to a selected temperature T₀. The processing unit 33 is also capable of controlling the means 11 for generating and applying a sinusoidal excitation so that they generate a sinusoidal oscillatory deformation of the sample 10 at a selected frequency f₁. The frequency f₁ and the temperature T₀ are for example chosen by a user using the interface means 35.

Furthermore, the processing unit 33 is capable of receiving the signals Ds(t), As(t) and Fs(t) respectively received from the dynamic movement sensor, the accelerometer, and the force sensor 30, and analyzing the signals to determine the characteristics of the nonlinear response of the sample 10 to the excitation to which it is subjected.

FIG. 2 is an overview diagram illustrating the method for characterizing the viscoelastic properties of a material according to one embodiment of the invention, implemented using a characterization system as described in reference to FIG. 1.

In the rest of the description of FIG. 2, it will be considered that the sample 10 is a solid material with a parallelepiped shape, with height h and cross-section S. This height h is thus equal to the distance between the two support elements 23 and 25 when no deformation is applied to the sample 10.

During a step 50 for defining the experimental conditions, the temperature T₀ of the enclosure 7, the frequency f₁ and the amplitude ε₁ of the deformation applied to the sample 10 are chosen, by a user or by the processing unit 33, in particular depending on the type of material analyzed and the geometry of the sample.

Depending on the type of material and the geometry of the sample, the frequency f₁ is for example comprise between several millihertz and several hundred Hertz, and the amplitude ε₁ between 1 μm and 6 mm.

The processing unit 33 then controls the thermostatically-controlled enclosure 7 so that its inner temperature is equal to the defined temperature T₀, and monitors the temperature of that enclosure using means 31 for measuring the temperature.

Then, in a step 52, the sample 10 is subjected to a sinusoidal deformation.

To that end, the processing unit 33 sends a command signal to the means 11 for generating and applying a sinusoidal excitation so that they apply a sinusoidal oscillatory deformation to the sample 10, for example in uniaxial traction-compression along the axis A.

In response to that command, the generator 27 generates a sinusoidal electric current with frequency f₁ and an amplitude proportional to the amplitude ε₁. That current is received by the electrodynamic exciter 29, which then generates a sinusoidal oscillatory movement of the second support element 25 with frequency f₁ and amplitude D₁.

The sample 10, fixed both to the first support element 23, which is stationary relative to the frame 19, and to the second support element 25, which is movable relative to the frame 19, is thus subject to a sinusoidal traction-compression deformation, of form:

$$ɛ = {ɛ}_{1} sin ( 2 π {f}_{1} t ) \\ with {ɛ}_{1} = \frac{{D}_{1}}{h} . \qquad ( 2 )$$

In response to that deformation, the sample 10 transmits a dynamic force F_{d} to the first support element 23. Thus, during a step 54 that is concomitant with the step 52, the dynamic force F_{d} transmitted by the sample is measured by the dynamic force sensor 30, which transmits electrical signal Fs(t) that is characteristic of that force F_{d} to the processing unit 33.

In parallel, the dynamic movement sensor measures the displacement D generated by the electrodynamic exciter 29, generates an electric signal Ds(t) that is characteristic of that displacement D, and transmits the signal Ds(t) to the processing unit 33.

Likewise, the accelerometer measures the acceleration generated by the electrodynamic exciter 29, generates an electric signal As(t) that is characteristic of that acceleration, and transmits that signal As(t) to the processing unit 33.

The processing unit 33 receives the electric signals Ds(t), As(t) and Fs(t), and deduces therefrom the instantaneous deformation ε(t) applied to the sample 10 as well as the instantaneous stress σ(t) transmitted by that sample, in particular from relationships (1) and (2) above.

In a step 56, the processing unit 33 then analyzes the stress σ(t) transmitted by the sample 10 in response to the deformation ε(t), and deduces therefrom the characteristic parameters of the viscoelastic properties of the sample 10.

The deformation ε(t) applied to the sample 10, which is proportional to the displacement D induced by the electrodynamic exciter 29, is a sinusoidal deformation, of form:

ε=ε₁ sin(2πf₀t).

However, the stress σ(t) transmitted by the sample 10 is not exactly a linear function of time. This stress σ(t) may in fact be expressed as a periodic or quasi-periodic function whereof it is possible to measure an amplitude, frequency, and phase shift relative to the deformation ε(t), but that function is a nonlinear function.

Any simple periodic signal, i.e., having a maximum and minimum per period, can be described using the following form:

x(t)=x₀+x₁ cos(φ(t)) (3)

wherein the entire time dependence is contained in the phase function φ, where x₁ designates the amplitude of the signal x(t) and x₀ is its mean value.

Thus, the signal corresponding to the stress σ(t) transmitted by the sample 10 can be expressed using the general form:

σ(t)=σ₀+σ₁ cos(φ(t)−ρ₀) (4)

wherein φ(t) designates the phase function of the signal σ(t), p₀ is a phase origin, σ₀ is the mean value of the signal σ(t), quasi-zero, and σ₁ is its amplitude. It should be noted that the expression cos(φ(t)−ρ₀) could be denoted cos(φ(t)) by integrating p₀ into φ(t).

Furthermore, the mean value here refers to the average between the maximum and minimum values of the signal (t), respectively equal to (σ₀+σ₁) and (σ₀−σ₁).

However, in an anharmonic periodic signal, the main contribution to the anharmonicity comes from the breaking of symmetry of the phase dynamics. Thus, all of the relevant dynamic information is expressed by the phase dynamics. During the analysis of the signal σ(t), that phase φ(t) should therefore be studied, and in particular the phase dynamics expressed by the function F, derived from the function φ relative to the time t:

$$F ( Φ ) = \frac{d Φ}{d t} \qquad ( 5 )$$

Thus, the morphology of the signal is completely determined by the knowledge of F.

The analysis step 56 of the method according to the invention therefore consists of describing this function F using a small number of parameters having a physical meaning, precisely characterizing the signal σ(t), therefore the viscoelastic properties of the sample 10.

This analysis step 56 thus comprises a first step consisting of expressing the phase φ and in particular the function F, derived from φ relative to the time.

We will first consider signals with period 2π, equivalent expressions for a signal with any frequency f₁ being obtained by replacing, in the following expressions, the time t with 2πf₁t.

In the simplest case, and for a signal with period 2π, the phase dynamics can be written in the form:

$$F ( Φ ) = \frac{d Φ}{d t} = \frac{1 + {r}_{0}^{2} + 2 {r}_{0} cos ( Φ )}{1 - {r}_{0}^{2}} \qquad ( 6 )$$

called phase equation.

The function F in this case has a reflection symmetry relative to the axis φ=0. This expression of the phase dynamics only contains a single parameter, r₀, which varies in the interval [0,1[. The bound r₀=0 corresponds to a harmonic signal, i.e., linear, the bound r₀=1 to an infinitely enharmonic signal, i.e., infinitely nonlinear.

The phase φ can in this case be expressed in the form:

$$Φ ( t ) = t + 2 {tan}^{- 1} ( \frac{{r}_{0} sin ( t )}{1 - {r}_{0} cos ( t )} ) \qquad ( 7 )$$

The signal σ(t) is broken down and rewritten in a form involving, aside from the values σ₀ and σ₁, the parameters r₀ and ρ₀:

σ(t)=σ₀+a₁h cos(t,r₀)+b₁h sin(t,r₀) (8)

with a₁=σ₁ cos(ρ₀) and b₁=σ₁ sin(ρ₀), and in which the following functions h cos and h sin are defined:

$$\begin{matrix}h cos \text{:} ( t , r ) -> \frac{( 1 + {r}^{2} ) cos ( t ) + 2 r}{1 + {r}^{2} - 2 r cos ( t )} & ( 9 ) \\ h sin \text{:} ( t , r ) -> \frac{( 1 - {r}^{2} ) sin ( t )}{1 + {r}^{2} - 2 r cos ( t )} & ( 10 )\end{matrix}$$

Thus, the decomposition of the signal σ(t) only involves two parameters, r₀ and ρ₀.

r₀, called anharmonicity parameter, measures the degree of nonlinearity of the signal σ(t), the bound r₀=0 corresponds to a linear signal, the bound r₀=1 to an infinitely nonlinear signal. Furthermore, the parameter ρ₀, which defines the composition of the signal in the two functions h cos and h sin, is a morphology parameter, which corresponds to the angle of reflection symmetry of the phase dynamics.

In the general case, i.e., for any periodic signal, the phase equation can be written in the following form:

$$F ( Φ ) = \frac{{P}_{n} ( Φ )}{{Q}_{m} ( Φ )} \qquad ( 11 )$$

wherein Pₙ and Qₘ are trigonometric polynomials of respective degrees n and m they can be different. The general form of the trigonometric polynomial of degree n is:

$${P}_{n} ( Φ ) = {α}_{0} + {\sum }_{k = 1}^{n} {α}_{k} cos ( k Φ ) + {β}_{k} sin ( k Φ ) \\ Likewise , {Q}_{m} ( Φ ) = {α}_{0}^{′} + {\sum }_{k = 1}^{m} {α}_{k}^{′} cos ( k Φ ) + {β}_{k}^{′} sin ( k Φ ) . \qquad ( 12 )$$

The analysis 56 of the signal σ(t) then consists of determining an expression of φ involving a small number of characteristic parameters, which makes it possible to characterize that signal σ(t), therefore the viscoelastic properties of the sample 10 using parameters accurately translating the response of that sample to an excitation, and in particular the nonlinear components of that response.

Advantageously, the phase equation (5) can be rewritten in the form:

$$\frac{1}{F ( Φ )} = \frac{d t}{d Φ} = \frac{{Q}_{m} ( Φ )}{{P}_{n} ( Φ )} \qquad ( 13 )$$

The factorization of the polynomial Pₙ(φ) in the form:

$${P}_{n} ( Φ ) = {α}_{0} {\prod }_{k = 1}^{n} ( 1 + {r}_{k}^{2} - 2 {r}_{k} cos ( Φ - {p}_{k} ) ) \qquad ( 14 )$$

wherein the parameters rₖ are comprised between 0 and 1, makes it possible to rewrite equation (13) in the form:

$$\frac{1}{F ( Φ )} = \frac{{α}_{0}^{′} + {\sum }_{k = 1}^{m} {α}_{k}^{′} cos ( k Φ ) + {β}_{k}^{′} sin ( k Φ )}{{α}_{0} {\prod }_{k = 1}^{n} ( 1 + {r}_{k}^{2} - 2 {r}_{k} cos ( Φ - {p}_{k} ) )} \qquad ( 15 )$$

Through a traditional identification, similar to an identification making it possible to break a rational fraction down into simple elements, it is possible to transform

$$\frac{1}{F ( Φ )}$$

into a sum of simple terms, which makes it possible to rewrite the phase equation in the form:

$$\frac{d t}{d Φ} = {a}_{0} + {\sum }_{k = 1}^{n} \frac{{a}_{k} cos ( Φ - {p}_{k} ) + {b}_{k} sin ( Φ + {p}_{k} )}{( 1 + {r}_{k}^{2} - 2 {r}_{k} cos ( Φ + {p}_{k} ) )} \qquad ( 16 )$$

wherein the parameters rₖ, comprised between 0 and 1, measure the nonlinearity of the signal σ(t), and the parameters ρₖ characterize its morphology.

The period T=1/f of the signal can be determined by integrating that equation relative to φ, between 0 and 2π:

$$T = {\int }_{Φ = 0}^{Φ = 2 π} \frac{d Φ}{F ( Φ )} = 2 π ( {a}_{0} + {\sum }_{k} \frac{{r}_{k} {a}_{k}}{1 - {r}_{k}^{2}} ) \qquad ( 17 )$$

From this result, and stresses according to which the period is equal to 2π and the signal is harmonic when the coefficients rₖ are all zero, the phase equation can be expressed as follows:

$$\frac{d t}{d Φ} = 1 + {\sum }_{k = 1}^{n} {D}_{k} ( Φ - {p}_{k} ) \qquad ( 18 )$$

where the function Dₖ is defined by:

$${D}_{k} \text{:} Φ -> \frac{{r}_{k} ( {a}_{k} cos ( Φ ) + {b}_{k} sin ( Φ ) - {a}_{k} )}{( 1 + {r}_{k}^{2} - 2 {r}_{k} cos ( Φ ) )} \qquad ( 19 )$$

and verifies:

$${\int }_{Φ = 0}^{Φ = 2 π} {D}_{k} ( Φ ) d Φ = 0 \qquad ( 20 )$$

The definition of the functions poly cos and poly sin, denoted p cosₙ and p sinₙ, which are expressed by:

$$\begin{matrix}p {cos}_{n} ( t , r ) = {\sum }_{k = 1}^{∞} cos ( k t ) \frac{{r}^{k}}{{k}^{n}} & ( 21 ) \\ p {sin}_{n} ( t , r ) = {\sum }_{k = 1}^{∞} sin ( k t ) \frac{{r}^{k}}{{k}^{n}} & ( 22 )\end{matrix}$$

and have, inter alia, the following properties:

$$\begin{matrix}p {cos}_{0} ( t , r ) = \frac{r ( cos ( t ) - r )}{1 + {r}^{2} - 2 r cos ( t )} & ( 23 ) \\ p {sin}_{0} ( t , r ) = \frac{r sin ( t )}{1 + {r}^{2} - 2 r cos ( t )} & ( 24 ) \\ p {cos}_{1} ( t , r ) = - \frac{1}{2} ln ( 1 + {r}^{2} - 2 r cos ( t ) ) & ( 25 ) \\ p {sin}_{1} ( t , r ) = {tan}^{- 1} ( \frac{r sin ( t )}{1 - r cos ( t )} ) & ( 26 )\end{matrix}$$

makes it possible to rewrite the equation in the form:

$$\frac{d t}{d Φ} = 1 + {\sum }_{k = 1}^{n} {a}_{k} p {cos}_{0} ( Φ - {p}_{k} , {r}_{k} ) + {b}_{k} p {sin}_{0} ( Φ - {p}_{k} , {r}_{k} ) \qquad ( 27 )$$

The resolution of this equation makes it possible to access an analytic expression of t(φ), which can be expressed as:

$$t ( Φ ) = Φ + {\sum }_{k = 1}^{n} {a}_{k} p {sin}_{1} ( Φ - {p}_{k} , {r}_{k} ) - {b}_{k} p {cos}_{1} ( Φ - {p}_{k} , {r}_{k} ) \qquad ( 28 )$$

The time t is therefore expressed as a function of the phase φ, and dually, the phase φ is expressed as a function of time t, using clearly defined independent parameters, which measure the anharmonicity (parameters r or rₖ), and the morphology (parametersp₀ four pₖ).

The phase φ can therefore be expressed as a function of time t in a form equivalent (or dual) to that of t(φ):

$$Φ ( t ) = t + {\sum }_{k = 1}^{n} {a}_{k} p {sin}_{1} ( t - {t}_{k} , {r}_{k} ) - {b}_{k} p {cos}_{1} ( t - {t}_{k} , {r}_{k} ) \qquad ( 29 )$$

wherein the parameters aₖ, bₖ and rₖ are generally different from the parameters aₖ, bₖ and rₖ of expression (28).

The expression of σ(t) is then obtained by replacing φ (t) with the expression (29) in equation (4).

Furthermore, equivalent expressions are obtained for a signal with any frequency f₁, by replacing, in the preceding expressions, the time t with 2πf₁t. In particular, the function φ(t)−2πf₁t is periodic with period 1/f₁.

One can also see that by positing a₁=2, aₖ=0 for any k>1, bₖ=0 for any k and t₁=0, one obtains:

$$Φ ( t ) = t + 2 p {sin}_{1} ( t , {r}_{1} ) = t + 2 {tan}^{- 1} ( \frac{{r}_{1} sin ( t )}{1 - {r}_{1} cos ( t )} ) ,$$

which corresponds to equation (7) giving the expression for the phase φ (t) in the simplest case.

Thus, during the analysis step 56, the processing unit 33 analyzes the signal σ(t) and in particular expresses its phase function φ(t) as a function of parameters characterizing that signal σ(t), therefore the viscoelastic properties of the sample 10.

According to one embodiment, the stress signal σ(t) is described quasi-exactly by a period T (or a frequency f₁), an amplitude σ₁, a harmonicity r₀ and a morphology ρ₀.

According to another embodiment, the stress signal σ(t) is described still more accurately by two pairs of parameters (r₁, t₁) and (r₂, t₂), completed by their respective weights (which corresponds to the case where n=2).

The choice of the model, i.e., the expression (7) of φ(t) corresponding to the simple case to model the phase, or the expression (29) and the integer n, can be made using typical modeling techniques.

In particular, an effort should first be made to model the signal using the expression (8), while seeking to minimize the deviation (for example, the standard deviation) between the model and the signal σ(t), by adjusting the values of the parameters p₀, r₀, σ₀, σ₁ and the period, until that deviation reaches a value for example set in advance.

If that value cannot be reached, a more complex model should be chosen. Reference is then made to the general expression (29), first choosing n=1, the expression of σ(t) then involving the pair of parameters (r₁, t₁) as well as the weights a₁ and b₁.

Likewise, it is possible to increase the value of n until a satisfactory model is obtained. However, the value n=2 is generally sufficient to model a nonlinear periodic response signal as specified above.

The stress σ transmitted by the sample 10 in response to the deformation ε is therefore characterized not only by its amplitude σ₁, but also by harmonicity and morphology parameters. Thus, that stress σ is described much more accurately than by using the methods of the state of the art, which only account for the amplitude and phase shift of that stress relative to the deformation.

Then, during a step 58, the processing unit 33 analyzes the results of the step 56, i.e., the parameters σ₁, rₖ, p₀, tₖ, aₖ and bₖ characterizing the stress σ, in light of the excitation signal, i.e., the deformation ε=ε₁ sin(2πf₁t).

Then, during the steps 56 and 58 of the method according to the invention, the processing unit 33 characterizes the viscoelastic properties of the sample 10 while using the response of that sample to an excitation more accurately and more completely than the methods according to the state of the art.

The characteristic parameters determined depend on experimental parameters such as the temperature T₀ of the enclosure 7, therefore of the sample, the frequency f₁ of the excitation, and its amplitude ε₁.

The steps 50 to 58 of the method are thus reiterated, modifying at least one of these experimental parameters upon each trial, so as to characterize the behavior of the material of the sample 10 under different biasing conditions.

For example, several trials, i.e., several sequences of steps 50 to 58, can be implemented while scanning frequencies and/or temperatures.

The processing unit 33 then synthesizes the characteristic parameters of the viscoelastic properties of the sample 10 determined during each of these trials, for example by commanding the display by the display device 37 of curves showing the variation of those characteristic parameters as a function of the experimental parameters modified between each trial.

The method according to the invention thus makes it possible to extract, from a response signal of a sample to an excitation, any information carried by that signal, without being limited to its linear characteristics, and thus to characterize the viscoelastic properties of the analyzed material accurately and relevantly.

It should, however, be understood that the example embodiment presented above is not limiting.

In particular, according to another embodiment, the excitation which the sample is subjected is a stress σ, and the measured response to that excitation is the deformation of the sample, the characteristics of that deformation being analyzed similarly to the step 56 described above. In this embodiment, the measured response is thus the displacement D, from which the deformation ε of the sample is deduced.

Furthermore, the analyzed sample is not necessarily a sample of a solid material. According to other embodiments, the sample may be a biological tissue or a fluid.

Furthermore, although the deformation mode described above is a traction-compression deformation, other deformation modes can be considered, the deformation mode being chosen in particular as a function of the nature of the studied substance (solid or fluid) and its modulus of elasticity.

Thus, according to another embodiment, the deformation applied is a bending deformation. This deformation mode is particularly suitable for materials with a high modulus of elasticity (greater than approximately 10 GPa). The characterization system and method are then identical to the system and method described in reference to FIGS. 1 and 2, with the exception of the means for fixing the sample to the viscoanalyzer. In fact, in that case said the fixing means comprise two stationary lower support elements, designed to receive the sample in a horizontal position, and one movable upper support, indirectly fixed to the upper crosspiece 21 of the frame 17, between the two lower support elements, and designed to impose bending on the sample.

According to another embodiment, the deformation applied is a shearing deformation. This deformation mode is suitable for materials with a lower modulus of elasticity.

A shearing deformation is also suitable for studying substances such as fluids. The means for fixing the sample described in FIG. 1 are then replaced by a bucket with a hollow cylindrical shape, connected to the lower crosspiece 19 of the frame 17, and designed to receive the fluid sample, and by a vibrating cylindrical piston, indirectly fixed to the upper crosspiece 21 of the frame 17, with a diameter smaller than the lower diameter of the bucket, and designed to apply an oscillatory shearing to the fluid contained in that bucket.

According to another embodiment, the oscillatory excitation applied to the studied sample is in turn a nonlinear execution, for example a deformation of form:

ε(t)=ε₀+ε′₁h sin(2πf₁t, r₀)+ε″₁h cos(2πf₁t, r₀)

wherein the parameters ε₀, ε′₁, ε″₁, f₁ and r₀ can be chosen by a user.

Of course, still other embodiments can be considered.

1. A method for characterizing the viscoelastic properties of a sample (10) of a substance, comprising the application (52) to said sample (10) of an oscillatory mechanical excitation (ε(t); σ(t)), the measurement (54) of a response (F_{d}; D) of said sample (10) to said mechanical excitation (ε(t); σ(t)), and the determination (56, 58) of characteristic parameters (σ₁, p₀, rₖ, tₖ, aₖ, bₖ) of said viscoelastic properties of said sample (10), characterized in that the determination (56, 58) of said characteristic parameters (σ₁, p₀, rₖ, tₖ, aₖ, bₖ) comprises the following steps:
expressing said response in the form of a nonlinear periodic response signal (σ(t);ε(t)), of general form x(t)=x₀+x₁ cos(φ(t)−p₀), where φ(t) is the phase of said signal and p₀ a phase origin, and
determining viscoelasticity parameters (σ₁, rₖ, p₀, tₖ, aₖ, bₖ), characterizing the nonlinearity of said response signal (σ(t);ε(t)).

2. The method according to claim 1, characterized in that the step for determining viscoelasticity parameters (σ₁, p₀, rₖ, tₖ, aₖ, bₖ) comprises the determination of an expression of the phase φ(t) of said response signal (σ(t);ε(t)) as a function of the viscoelasticity parameters (rₖ, tₖ, aₖ, bₖ) measuring the anharmonicity of the response signal and its morphology, from functions p cosₙ and p sinₙ defined by:
$$p {cos}_{n} ( t , r ) = {\sum }_{k = 1}^{∞} cos ( k t ) \frac{{r}^{k}}{{k}^{n}} and p {sin}_{n} ( t , r ) = {\sum }_{k = 1}^{∞} sin ( k t ) \frac{{r}^{k}}{{k}^{n}} .$$

3. A method according to claim 2, characterized in that the determination of an expression of the phase φ(t) of said response signal (σ(t);ε(t)) comprises the determination of an expression of a phase equation
$$F ( Φ ) = \frac{d Φ}{d t}$$
characterizing a variation speed of said phase φ(t).

4. The method according to claim 3, characterized in that said phase equation is expressed in the form:
$$\frac{d Φ}{d t} = \frac{1 + {r}^{2} + 2 r cos ( Φ )}{1 - {r}^{2}}$$
wherein r, varying in [0,1[, is a parameter measuring the nonlinearity of said response signal (σ(t);ε(t)).

5. The method according to claim 4, characterized in that the response signal (σ(t); ε(t)) is expressed using at least two viscoelasticity parameters r and p₀ respectively characterizing the nonlinearity and the morphology of the response signal (σ(t); ε(t)), in the form:
x(t)=x₀+aᵢh cos(2πf₁t, r)+b₁h sin(2πf₁t,r)
where f₁ is the frequency of the signal, a₁=x₁ cos(p₀) and b₁=x₁ sin(p₀), the functions h sin and h cos being defined by:
$$h cos \text{:} ( t , r ) -> \frac{( 1 + {r}^{2} ) cos ( t ) + 2 r}{1 + {r}^{2} - 2 r cos ( t )} and$$
$$h sin \text{:} ( t , r ) -> \frac{( 1 - {r}^{2} ) sin ( t )}{1 + {r}^{2} - 2 r cos ( t )}$$

6. The method according to claim 3, characterized in that said phase equation is expressed in the form:
$$F ( Φ ) = \frac{P ( Φ )}{Q ( Φ )} ,$$
wherein P(φ) and Q(φ) are trigonometric polynomials.

7. The method according to claim 6, characterized in that the expression of the phase φ(t) is determined as a function of the viscoelasticity parameters aₖ, bₖ, rₖ and tₖ in the form:
$$Φ ( t ) = 2 π {f}_{1} t + {\sum }_{k = 1}^{n} {a}_{k} p {sin}_{1} ( 2 π {f}_{1} ( t - {t}_{k} ) , {r}_{k} ) - {b}_{k} p {cos}_{1} ( 2 π {f}_{1} ( t - {t}_{k} ) , {r}_{k} )$$
wherein f₁ is the frequency of the signal and the functions p sin₁ and p cos₁ are defined by:
$$p {cos}_{1} ( t , r ) = {\sum }_{k = 1}^{∞} cos ( kt ) \frac{{r}^{k}}{k} = - \frac{1}{2} ln ( 1 + {r}^{2} - 2 r cos ( t ) ) and$$
$$p {sin}_{1} ( t , r ) = {\sum }_{k = 1}^{∞} sin ( kt ) \frac{{r}^{k}}{k} = p {sin}_{1} ( t , r ) = {tan}^{- 1} ( \frac{r sin ( t )}{1 - r cos ( t )} ) .$$

8. A system for characterizing viscoelastic properties of a sample (10) of a substance, comprising means (11) for the application to said sample (10) of an oscillatory mechanical excitation, means (15) for the measurement of a response of said sample (10) to said mechanical excitation, and means (33) for the determination of characteristic parameters (σ₁, p₀, rₖ, tₖ, aₖ, bₖ) of said viscoelastic properties of said sample (10), characterized in that said means (33) for the determination of said characteristic parameters (σ₁, p₀, rₖ, tₖ, aₖ, bₖ) comprise:
means for expressing said response in the form of a nonlinear periodic response signal (σ(t);ε(t)), of general form x(t)=x₀+x₁ cos(φ(t) −p₀), where φ(t) is the phase of said response signal and p₀ is a phase origin, and
means for determining viscoelasticity parameters characterizing the nonlinearity of said response signal (σ(t);ε(t)).

9. A dynamic mechanical analyzer comprising a characterization system according to claim 8.
